(19) United States
(12) Patent Application Publication
(10) Pub. No.: US 2024/0418455 A1
(43) Pub. Date: Dec. 19, 2024

(54) HEAT EXCHANGER CORE DESIGN

(71) Applicant: Hamilton Sundstrand Corporation, Charlotte, NC (US)

(72) Inventors: Tomasz MECZKOWSKI, Grajewo (PL); Sebastian Marcin ZURAW, Opole (PL); Hubert Jan SIUDZINSKI, Wroclaw (PL); Szymon BOROWSKI, Sobótka (PL); Stanislaw Jan ROSCISZEWSKI, Kraków (PL); Katarzyna Justyna GRZEBSKA, Wroclaw (PL); Wojciech Wladyslaw SLOMA, Krasne (PL); Ryan M. KELLEY, Granby, CT (US); Andrew M. CALDECUTT, Vernon, CT (US); Grum T. NGATU, South Windsor, CT (US)

(21) Appl. No.: 18/743,532

(22) Filed: Jun. 14, 2024

(30) Foreign Application Priority Data
Jun. 16, 2023 (EP) 23461605.0

(51) Int. Cl. F28F 1/02; B33Y 80/00

(52) U.S. Cl. CPC F28F 1/025; B33Y 80/00; F28F 2250/106

(57) ABSTRACT

A heat exchanger core includes a plurality of first medium channels along which a first medium is directed from a first first medium channel end to a second first medium end, and a plurality of second medium channels along which a second medium is directed from a first second medium channel end to a second second medium channel end. The first medium channels and/or the second medium channels are formed to have a first portion having a first cross-sectional shape and one or more second portions having a second, different cross-sectional shape. The channel transitions smoothly from the first to the second cross-sectional shape.

### CROSS-REFERENCE TO RELATED APPLICATIONS

This application claims the benefit of European Patent Application No. 23461605.0 filed Jun. 16, 2023, the disclosure of which is incorporated herein by reference in its entirety.

### TECHNICAL FIELD

The present disclosure is concerned with a heat exchanger, specifically the design of the core of a heat exchanger.

### BACKGROUND

Heat exchangers typically work by the transfer of heat between fluid flowing in parallel channels defined by metal plates of a heat exchanger core. A heat exchanger core is generally in the form of a block made up of layers of plates which define the channels through which the fluid flows. The channels are arranged such that hot fluid flows through some channels and cold fluid flows through other channels with the hot and cold channels arranged either vertically or horizontally adjacent each other such that heat is exchanged across the boundary between the channels. Thermal properties are improved by the introduction of turbulence in the flow channels and so, conventionally, a heat exchanger core comprises corrugated metal plates arranged adjacent each other so as to define corrugated flow channels for the heat exchange fluids.

Additive manufacture, or 3D printing, has recently become a preferred manufacturing method for many parts and components due to the fact that it is relatively quick and low cost and allows for great flexibility in the design of new components and parts. Due to the fact that components and parts made by additive manufacture (AM) can be quickly made in a custom designed form, as required, AM also brings benefits in that stocks of components do not need to be manufactured and stored to be available as needed. AM parts can be made of relatively light, but strong materials. As AM is becoming more popular in many industries, there is interest in manufacturing heat exchangers using AM.

In conventional heat exchanger channels, the viscous fluids that are commonly used create a thick boundary layer at the walls of the channels. This boundary layer presents a resistance to heat exchange across the channel walls and reduces the amount of energy that can be transferred through the channel wall by heat exchange. Additive manufacturing provides the opportunity to create new shapes of heat exchanger channel to address this problem.

One type of AM heat exchanger design has a so-called weave core in which wavy channels are formed for the hot and cold fluid and the hot and cold fluid channels are interwoven in a continuous manner. Such designs are typically cross-flow designs where the hot fluid flows through wavy channels in one direction and the cold fluid flows through wavy channels interlaced through the hot flow channels in a direction transverse to the one direction. The integrated geometry of the weave makes such heat exchangers most suitable for single pass designs—i.e. where the hot and cold fluid enters their respective channels at one end on one side/end of the core and exits at the opposite end.

In applications where heat exchangers are used in high temperature conditions, and where the temperature difference between the first and second medium is large, thermal stresses at points of high temperature difference can result in thermal inefficiencies and even damage to the heat exchanger. There is a desire to provide a heat exchanger core design where such stresses can be reduced.

### SUMMARY

According to the disclosure, there is provided a heat exchanger core comprising a plurality of first medium channels along which a first medium is directed from a first first medium channel end to a second first medium end, and a plurality of second medium channels along which a second medium is directed from a first second medium channel end to a second second medium channel end, wherein the first medium channels and/or the second medium channels are formed to have a first portion having a first cross-sectional shape and one or more second portions having a second, different cross-sectional shape, wherein the channel transitions smoothly from the first to the second cross-sectional shape.

The heat exchanger core is preferably a cross-flow design, but may also be a counter-flow design.

In embodiments, the ends of either or both of the first medium channels and the second medium channels have the first cross-sectional shape along their length except for at one or both ends, where the shape is morphed to the first cross-sectional shape. In other embodiments, the shape may morph to the second cross-sectional shape at other locations along the channel length.

The core channels are preferably made using additive manufacturing, although it is conceivable that other manufacturing methods may be used.

Thermal stresses are usually highest at the interface of hot medium channels and so this is an ideal location for the shape change, but the change might provide benefits in cold channels.

Also provided is a heat exchanger comprising such a heat exchanger core.

### BRIEF DESCRIPTION OF THE FIGURES

Examples according to the disclosure will now be described with reference to the drawings. It should be noted that these are examples only and that variations are possible within the scope of the claims.

FIG. 1 is a 3D view of a heat exchanger which can have a core design according to the disclosure.

FIG. 2 shows a cross-section of part of a heat exchanger with a core design according to the disclosure.

FIG. 3 shows, in close-up, a detail of the heat exchanger of FIG. 2.

FIG. 4A shows a typical shape of channel outlets, for comparison.

FIG. 4B shows an example of channel outlet shapes according to this disclosure.

FIG. 5A shows an example of a channel formed according to this disclosure.

FIG. 5B shows a detailed view of an end of a channel such as shown in FIG. 5A.

FIG. 6 is an example of a heat exchanger core according to this disclosure.

### DETAILED DESCRIPTION

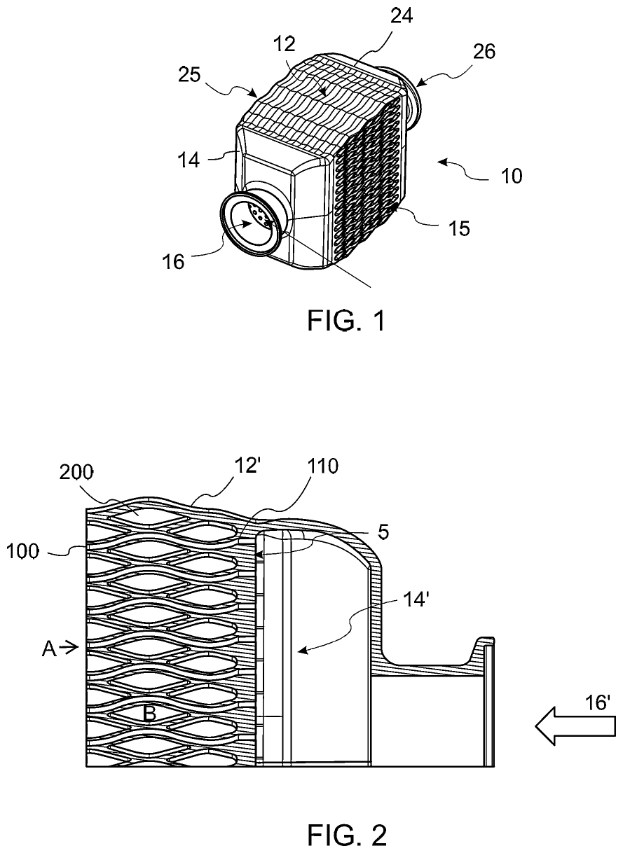

FIG. 1 shows a heat exchanger 10 the core 12 of which can be a typical heat exchanger core, but which can also have a heat exchanger core in accordance with the disclosure.

As is conventional, the heat exchanger 10 has a core 12 in the form of a block of channels for a first medium (e.g. hot air) and a second medium (e.g. cold air) arranged such that heat transfer takes place between the mediums where their channels contact each other. Some heat exchanger have a counter-flow design in which the channels of the first medium and the channels of the second medium are parallel but the first and second mediums flow in opposite directions. Other heat exchangers have a cross-flow design in which the channels of the first medium are directed across (perpendicular to) the channels of the second medium so that the first medium and the second medium flow across (perpendicular to) each other. The design shown in FIG. 1 is a cross-flow design. The first medium flows into the core 12 via a first manifold 14 at one end of the core 12, having a first medium inlet 16. A second manifold 24 is provided at the opposite end of the core 12 and has a first medium outlet 26. The first medium inlet and the first medium outlet are in fluid communication with respective ends of the channels for the first medium such that the first medium flows into the first medium inlet 16, through the channels for the first medium and out of the first medium outlet 26.

The second medium enters the channels for the second medium, which, in this example, are formed in the core 12 across the plane of the channels for the first medium. The second medium enters these channels at a second medium inlet 15, flows through the channels for the second medium, across the channels through which the first medium flow, thus exchanging heat with the first medium, and exits the core at the second medium outlet 25. At the respective outlet, the medium that is colder at the inlet has become warmer, and the medium that is warmer at the inlet has become cooler.

In order to provide improved heat transfer properties, and since additive manufacturing techniques have made it possible to easily manufacture different shapes of channels, many heat exchanger cores have wavy or woven channels rather than straight channels. A wavy channel improves heat transfer properties by creating turbulence as the medium flows through the channel, and can also increase the heat transfer area for a given length of channel. In such weave core designs, the hot medium and cold medium channels are interwoven in a cross-flow configuration.

In applications where heat exchangers are used in high temperature conditions, and where the temperature difference between the first and second medium is large, thermal stresses at points of high temperature difference can result in thermal inefficiencies and even damage to the heat exchanger. There is a desire to provide a heat exchanger core design where such stresses can be reduced.

The heat exchanger core design according to this disclosure reduces stresses at temperature difference interfaces by modifying the shape of channels through which one or both of the first and second medium flow, at locations along their length e.g. at their inlets and/or outlets and/or at other points between their inlet and outlet ends such that the channels have one or more locations where the channel transitions to have a shape (cross-sectional shape) that is different from the shape at other locations along the length.

This will be described further, by way of example, with reference to FIGS. 2 to 6.

FIG. 2 shows one end of a heat exchanger such as described above. It should be noted that the core channel design of this disclosure could be incorporated into different types of heat exchanger.

In the example shown, the heat exchanger core 12′ comprises a set of first medium channels 100 arranged for flow of a first medium from a first end 110 to a second, opposite end 112 (not shown in FIG. 2, but seen in FIG. 6) in a first direction A. A set of second medium channels 200 is interwoven between the first medium channels 100 and arranged for flow of a second medium from a first end to a second end in a cross-flow direction B (into the plane of the paper in FIG. 2) relative to the direction A of the first channels 100. As is known in the art, the channels have a wavy configuration from one end to the other. The first and second medium channels may have different cross-sections and patterns. In the example show, the first medium is a hot fluid and FIG. 2 shows the inlet 16′ at manifold 14′ via which the hot fluid (e.g. hot air) flows into the first medium channels 100 of the core 12′. The features of this disclosure can apply to the inlet end of the first (here hot) medium channels as shown. In addition, or alternatively, the features can be applied to the outlet end of those channels and/or the inlet and/or outlet ends of the second (here cold) medium channels and/or to other points along the first and/or second medium channels.

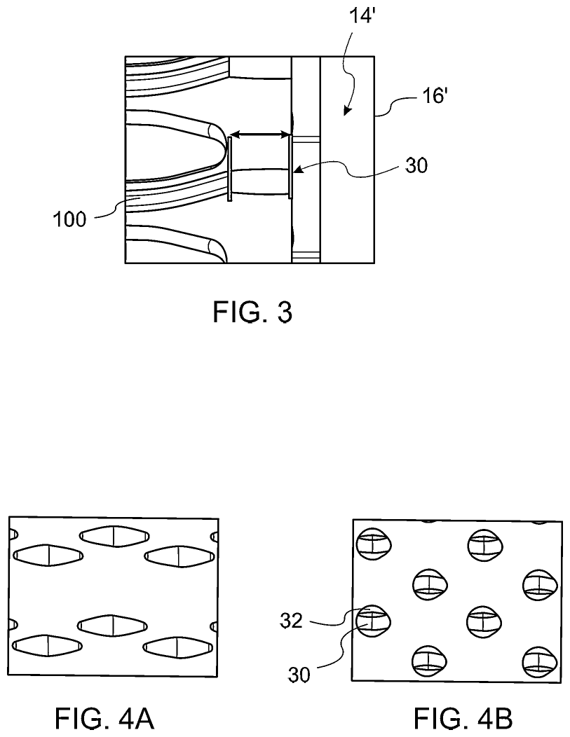

Particularly in high temperature conditions, as mentioned above, especially during heating or cooling, high thermal stresses occur e.g. in the region of the channel inlets and outlets and the manifolds where they interface with the core. To reduce the thermal stresses due to the large temperature difference occurring in such heat exchangers, the channels, according to this disclosure, have one or more portions along their length that is morphed to a different cross-sectional shape compared to other portions of the channel. One example of this, where the shape of the channels is morphed at the first medium inlet 16′, can best be seen in FIG. 3 which shows a ‘morphed’ section at the end of the channel 100. The length of the morphed section is not essential to the disclosure and will depend on the specific application. The morphed portion of the channel is particularly advantageous when used for channels in which the hot medium flows, but can still have advantages in cold medium channels.

The effect of the morphing of the channel at one portion (here the inlet end) can be seen by comparing FIGS. 4A and 4B. FIG. 4A shows channels with a uniform cross-sectional shape along their length as is conventional. In contrast, FIG. 4B shows the channels where one portion is morphed (i.e. transitions to a different cross-sectional shape—here more flattened) relative to other portions 32 of the channel.

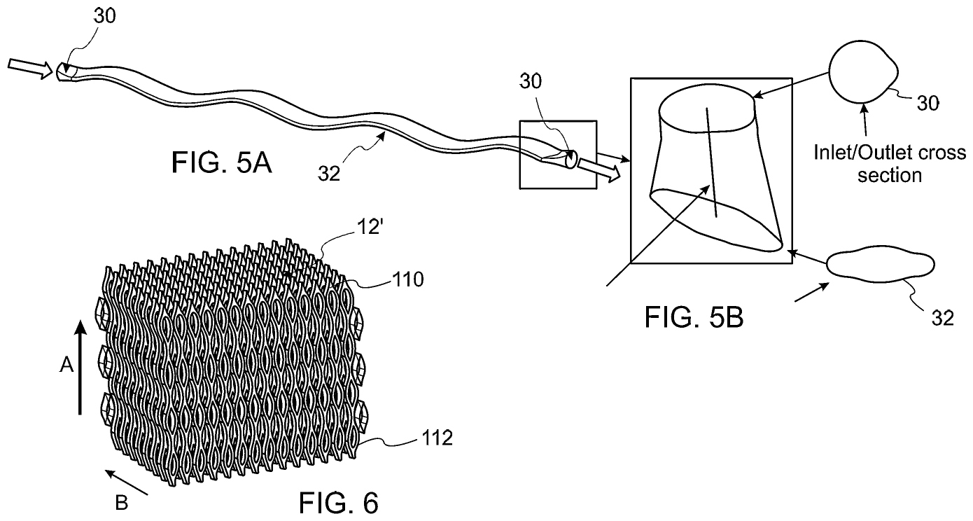

An example of a channel in which a portion (here the end) is morphed to have a different shape is seen in FIGS. 5A and 5B. The channel cross-sectional shape for the non-morphed portions (here between the ends) is a regular shape such as an elliptical or lozenge shape 32 whereas the end portions 30 are morphed or misshapen (e.g. to a circular or other shape) compared to the other portion 32. The cross-sectional shape of the morphed portion(s) may take one of a variety of shapes different from the shape of the non-morphed portion. The transition from the non-morphed shape to the morphed shape should be smooth and gradual to avoid further increases in stress.

The ‘morphing’ is a geometrical transition from one shape to another. The actual overall cross-sectional area of the channel, however, does not change substantially from the non-morphed portion to the morphed portion and so the shape change will not have a significant impact on pressure drop.

The design of the channels according to this disclosure allows thermal stresses at temperature interfaces e.g. between the core and the manifolds to be reduced making the heat exchanger more resistant to stress and the core more resistant to low cycle fatigue, LCF. It has been found that by providing a morphed portion in the channel, the stress of the whole core is reduced.

1. A heat exchanger core comprising:
a plurality of first medium channels along which a first medium is directed from a first first medium channel end to a second first medium channel end; and
a plurality of second medium channels along which a second medium is directed from a first second medium channel end to a second second medium channel end;
wherein the first medium channels or the second medium channels are formed to have a first portion having a first cross-sectional shape and one or more second portions having a second, different cross-sectional shape;
wherein the channel transitions smoothly from the first to the second cross-sectional shape.

2. The heat exchanger core of claim 1, wherein the plurality of first medium channels run in a direction transverse to the plurality of second medium channels.

3. The heat exchanger core of claim 2, further comprising:
a plurality of layers each having a plurality of first medium channels, each layer separated by a layer of second medium channels.

4. The heat exchanger core of claim 1, wherein the one or more second portions is provided at one or both ends of the first medium channels and the first portion is the portion of the first medium channels between the ends.

5. The heat exchanger core of claim 1, wherein the one or more second portions is provided at one or more locations between the ends of the first medium channels.

6. The heat exchanger core of claim 1, wherein the first cross-sectional shape is an elliptical shape and the second cross-sectional shape is a non-elliptical shape.

7. The heat exchanger core of claim 1, wherein the second cross-sectional shape is a substantially circular shape.

8. The heat exchanger core of claim 1, wherein the first medium is a hot fluid and the second medium is a cold fluid.

9. The heat exchanger core of claim 1, formed by additive manufacture.

10. A heat exchanger comprising:
an inlet manifold;
an outlet manifold; and
a heat exchanger core as claimed in claim 1 located with and in fluid communication with the inlet manifold and the outlet manifold.

11. The heat exchanger of claim 10, wherein the first first medium channel end is in fluid communication with the inlet manifold and the second first medium channel end is in fluid communication with the outlet manifold.

12. The heat exchanger of any claim 10, further comprising:
a second fluid inlet in fluid communication with the first second medium channel end and a second fluid outlet in fluid communication with the second second medium channel end.

13. The heat exchanger of claim 10, being a cross-flow heat exchanger.

14. The heat exchanger of claim 10, being a counter-flow heat exchanger.
